(19) United States
(12) Patent Application Publication
(10) Pub. No.: US 2019/0197929 A1
(43) Pub. Date: Jun. 27, 2019

(54) DRIVING APPARATUS OF DISPLAY PANEL AND OPERATION METHOD THEREOF

(71) Applicant: Novatek Microelectronics Corp., Hsinchu (TW)

(72) Inventors: Shu-Huan Hsieh, Changhua County (TW); Chia-Yin Chiang, Hsinchu County (TW)

(73) Assignee: Novatek Microelectronics Corp., Hsinchu (TW)

(21) Appl. No.: 16/121,636

(22) Filed: Sep. 5, 2018

Related U.S. Application Data
(60) Provisional application No. 62/610,291, filed on Dec. 26, 2017.

(51) Int. Cl. G09G 3/00; G09G 3/20

(52) U.S. Cl. CPC G09G 3/006; G09G 3/2003; G09G 2370/08; G09G 2340/0435; G09G 2330/12

(57) ABSTRACT

A driving apparatus of a display panel and an operation method are provided. The driving apparatus includes a command interface circuit, a video interface circuit, a built-in self test (BIST) circuit, a multiplex circuit and a driving circuit. The command interface circuit receives a test command including a grayscale parameter. The video interface circuit receives video frame data. The BIST circuit generates test frame data representing a test pattern according to the test command and sets a grayscale of the test pattern according to the grayscale parameter included in the test command. The multiplex circuit selects to output the test frame data in a test mode and selects to output the video frame data in a normal operation mode. The driving circuit drives the display panel to display an image according to the test frame data or the video frame data output from an output terminal of the multiplex circuit.

### CROSS-REFERENCE TO RELATED APPLICATION

This application claims the priority benefit of U.S. provisional application Ser. No. 62/610,291, filed on Dec. 26, 2017. The entirety of the above-mentioned patent application is hereby incorporated by reference herein and made a part of this specification.

### BACKGROUND

### Field of the Invention

The invention relates to a display apparatus and more particularly to a driving apparatus of a display panel and an operating method thereof.

### Description of Related Art

Generally, during a production process of display apparatuses, a manufacturer needs to adjust and calibrate various display parameters of the display apparatuses. For example, the manufacturer needs to adjust and calibrate gamma curves and/or color temperatures of the display apparatuses during the production process. Before adjusting and calibrating the gamma curves and/or the color temperatures, the manufacturer needs to measure brightness values and/or color coordinate values of specific test images (test patterns). A test system (test platfonn) has to transmit the specific test images (test frame data) to a display driving integrated circuit through a video interface of the display driving integrated circuit, such that the display driving integrated circuit may drive a flat-panel display module to display the aforementioned specific test images. Generally, the video interface may be a low-voltage differential signal (LVDS) interface. During a period in which the flat-panel display module displays the specific test images, the manufacturer may use an optical instrument to measure the brightness values and the color coordinate values of the images displayed by the flat-panel display module to serve as databases required for the gamma curves and the color temperatures. With the databases, the test system may calculate a red gamma curve, a green gamma curve, a blue gamma curve, color temperatures and/or other display parameters of the flat-panel display module.

After calculating the display parameters, the test system (the test platform) may burn the display parameters into a one-time programming (OTP) element, an electrically erasable programmable read only memory (EEPROM) or any other memory in the display driving integrated circuit through a command interface of the display driving integrated circuit. Generally, the command interface may be a serial peripheral interface (SPI) or an inter-integrated circuit (I²C).

Thus, the test system (the test platform) has to be capable of providing the specific test images. In order to provide the specific test images (the test frame data), the test system (the test platfoiin) has to be designed in a more complicated manner. However, for reducing testing cost and improving testing efficiency, simplifying the design of the test system is an effective approach. When the test system no longer has to provide the specific test images (the test frame data) to the display driving integrated circuit, the testing cost may be reduced.

### SUMMARY

The invention provides a driving apparatus of a display panel and an operating method thereof which are capable of self-generating test frame data representing a test pattern.

According to an embodiment of the invention, a driving apparatus of a display panel for generating a plurality of test frame data in an optical measurement is provided. The driving apparatus includes a command interface circuit, a video interface circuit, a built-in self test (BIST) circuit, a multiplex circuit and a driving circuit. The command interface circuit is configured to receive a test command including a grayscale parameter. The video interface circuit is configured to receive video frame data. The BIST circuit is coupled to the command interface circuit to receive the test command. The BIST circuit generates test frame data representing a test pattern according to the test command and sets a grayscale of the test pattern according to the grayscale parameter included in the test command. The multiplexer circuit is coupled to the BIST circuit to receive the test frame data. The multiplexer circuit is coupled to the video interface circuit to receive the video frame data. The multiplex circuit is configured to select to output the test frame data in a test mode and select to output the video frame data in a normal operation mode. The driving circuit is coupled to an output terminal of the multiplex circuit. The driving circuit is configured to drive the display panel to display an image according to the test frame data or the video frame data output from the output terminal of the multiplex circuit.

According to an embodiment of the invention, a driving apparatus of a display panel for generating a plurality of test frame data in an optical measurement is provided. The driving apparatus includes a command interface circuit, a BIST circuit and a driving circuit. The command interface circuit is configured to receive a test command including a grayscale parameter. The BIST circuit is coupled to the command interface circuit to receive the test command. The BIST circuit generates test frame data representing a test pattern according to the test command and sets a grayscale of the test pattern according to the grayscale parameter included in the test command. The driving circuit is configured to drive the display panel to display the test frame data.

According to an embodiment of the invention, an operating method of a driving apparatus of a display panel is provided. The driving apparatus is configured to generate a plurality of test frame data in an optical measurement. The operating method includes: receiving a test command including a grayscale parameter by a command interface circuit; receiving video frame data by a video interface circuit; generating test frame data representing a test pattern according to the test command and setting a grayscale of the test pattern according to the grayscale parameter included in the test command by a BIST circuit; selecting to output the test frame data in a test mode by a multiplex circuit; selecting to output the video frame data in a normal operation mode by the multiplexer circuit; and driving the display panel to display an image according to the test frame data or the video frame data output by the multiplex circuit by a driving circuit.

According to an embodiment of the invention, an operating method of a driving apparatus of a display panel is provided. The driving apparatus is configured to generate a plurality of test frame data in an optical measurement. The operating method includes: receiving a test command including a grayscale parameter by a command interface circuit; generating test frame data representing a test pattern according to the test command and setting a grayscale of the test pattern according to the grayscale parameter included in the test command by a BIST circuit; and driving the display panel to display the test frame data by a driving circuit.

To sum up, the driving apparatus of the display panel and the operating method thereof provided by the embodiments of the invention can generate the test frame data representing the test pattern by using the BIST circuit. The grayscale of the test pattern can be dynamically set according to the grayscale parameter included in the test command from an external apparatus (e.g., a test system). Thus, the test frame data generated by the BIST circuit can be applied to adjust and calibrate display parameters (e.g., gamma curves and/or color temperatures). Because the driving apparatus can self-generate the test frame data representing the test pattern, the external apparatus (e.g., the test system) is not required to transmit the test frame data required for the measurement with a video interface.

To make the above features and advantages of the invention more comprehensible, embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic circuit block diagram illustrating a driving apparatus of a display panel according to an embodiment of the invention.

FIG. 2 is a flowchart illustrating an operating method of a driving apparatus of a display panel according to an embodiment of the invention.

FIG. 3 is a schematic circuit block diagram illustrating a driving apparatus of a display panel according to another embodiment of the invention.

FIG. 4 is a flowchart illustrating an operating method of a driving apparatus of a display panel according to another embodiment of the invention.

FIG. 5 is a schematic circuit block diagram illustrating the built-in self test (BIST) circuit depicted in FIG. 1 and/or FIG. 3 according to an embodiment of the invention.

### DESCRIPTION OF EMBODIMENTS

The term “couple (or connect)” herein (including the claims) are used broadly and encompass direct and indirect connection or coupling means. For example, if the disclosure describes a first apparatus being coupled (or connected) to a second apparatus, then it should be interpreted that the first apparatus can be directly connected to the second apparatus, or the first apparatus can be indirectly connected to the second apparatus through other devices or by a certain coupling means. Moreover, elements/components/steps with same reference numerals represent same or similar parts in the drawings and embodiments. Elements/components/notations with the same reference numerals in different embodiments may be referenced to the related description.

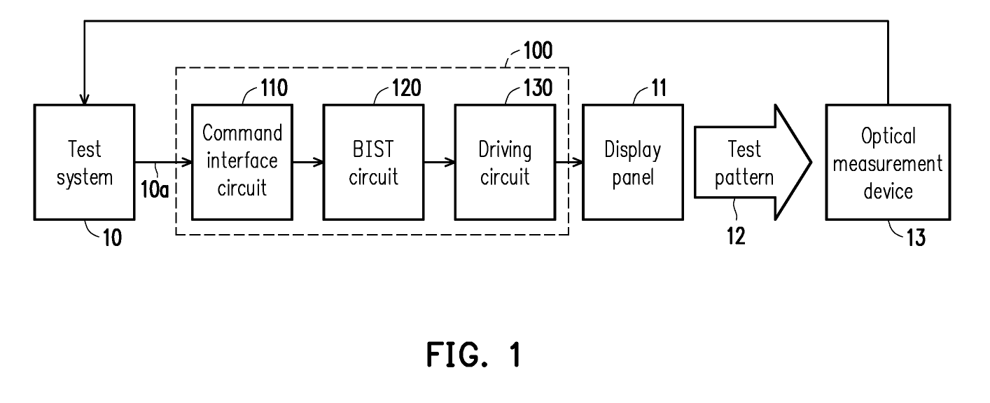

FIG. 1 is a schematic circuit block diagram illustrating a driving apparatus 100 of a display panel according to an embodiment of the invention. The driving apparatus 100 may generate a plurality of test frame data in an optical measurement. The driving apparatus 100 may drive a display panel 11 to display test frame data (e.g., a test pattern 12 which is also an image). The driving apparatus can be a display driver chip. Based on a design requirement, the display panel 11 may be a liquid crystal display panel, a light emitting diode panel, or any other flat-panel display module. During a period in which the display panel 11 displays the test pattern 12, an optical measurement device 13 may optically measure the test pattern 12 displayed by the display panel 11 and provide an optical measurement result to a test system (a test platform) 10. For instance, the optical measurement device 13 may measure brightness values and/or color coordinate values of images displayed by the display panel 11, and the test system 10 may serve the brightness values and/or the color coordinate values provided by the optical measurement device 13 as databases required for adjusting gamma curves and color temperatures of the driving apparatus.

More specifically, with these databases, the test system 10 may calculate a plurality of display setting parameters, for example, a red gamma curve, a green gamma curve, a blue gamma curve, a color temperature and/or other display setting parameters. The display setting parameters may include information associated with the test frame data. After calculating the display setting parameters, the test system 10 may store the display setting parameters into a memory (not shown) of the driving apparatus 100 (e.g., an one-time programming (OTP) circuit, an electrically erasable programmable read only memory (EEPROM) or any other memory) through a command interface circuit of the driving apparatus 100.

Based on a design requirement, in some other embodiments, the driving apparatus 100 may be coupled to a storage device (not shown). After calculating the display setting parameters, the test system 10 may store the display setting parameters in the storage device (not shown) through the driving apparatus 100. The driving apparatus 100 may drive the display panel 11 to display images according to the display setting parameters stored in the storage device.

In the embodiment illustrated in FIG. 1, the driving apparatus 100 can include at least a command interface circuit 110, a built-in self test (BIST) circuit 120 and a driving circuit 130. The driving circuit 130 may drive the display panel 11 to display an image. The implementation manner of the driving circuit 130 is not limited in the invention. For instance, the driving circuit 130 may include at least a conventional source driving circuit or another driving circuit. The command interface circuit 110 may receive a test command 10a including a grayscale parameter from the test system 10. The command interface circuit 110 may transmit the test command 10a to the BIST circuit 120. Based on a design requirement, the command interface circuit 110 may be a conventional command interface circuit or any other command interface circuit. For instance, the command interface circuit 110 may be a serial peripheral interface (SPI) circuit, an inter-integrated circuit (I²C) interface circuit or any other command interface circuit.

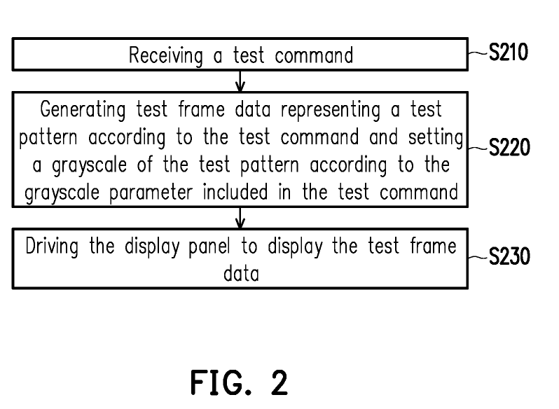

FIG. 2 is a flowchart illustrating an operating method of a driving apparatus of a display panel according to an embodiment of the invention. Referring to FIG. 1 and FIG. 2, the BIST circuit 120 is coupled to the command interface circuit 110 to receive a test command (step S210). In step S220, the BIST circuit 120 may generate test frame data representing the test pattern 12 according to the test command 10a. In step S220, the BIST circuit 120 may further set a grayscale of the test pattern 12 according to a grayscale parameter included in the test command 10a. In step S230, the driving apparatus 130 may drive the display panel 11 to display the test frame data (e.g., the test pattern 12 which is also an image).

A data structure of the test command 10a may be determined based on a design requirement. For instance, in some embodiments, the grayscale parameter included in the test command 10a includes a plurality of bits, and the bits are configured to set a grayscale for one of a red test pattern, a green test pattern and a blue test pattern. In some other embodiments, the grayscale parameter included in the test command 10a includes a plurality of first bits, a plurality of second bits and a plurality of third bits. The first bits are configured to set a red grayscale for a white test pattern, the second bits are configured to set a green grayscale for the white test pattern, and the third bits are configured to set a blue grayscale for the white test pattern. Thus, the BIST circuit 120 may set the grayscale of the test pattern 12 according to the grayscale parameter included in the test command 10a.

The driving apparatus 100 and the operating method thereof illustrated in FIG.1 and FIG. 2 may generate the test frame data representing the test pattern 12 by using the BIST circuit 120. The grayscale of the test pattern 12 may be dynamically set according to the grayscale parameter included in the test command 10a of the test system 10. Thus, the test frame data generated by the BIST circuit 120 may be applied to adjust and calibrate display parameters (e.g., gamma curves and/or color temperatures). Because the driving apparatus 100 is capable of self-generating the test frame data representing the test pattern 12, the test system 10 is not required to transmit test frame data required for the measurement with a video interface.

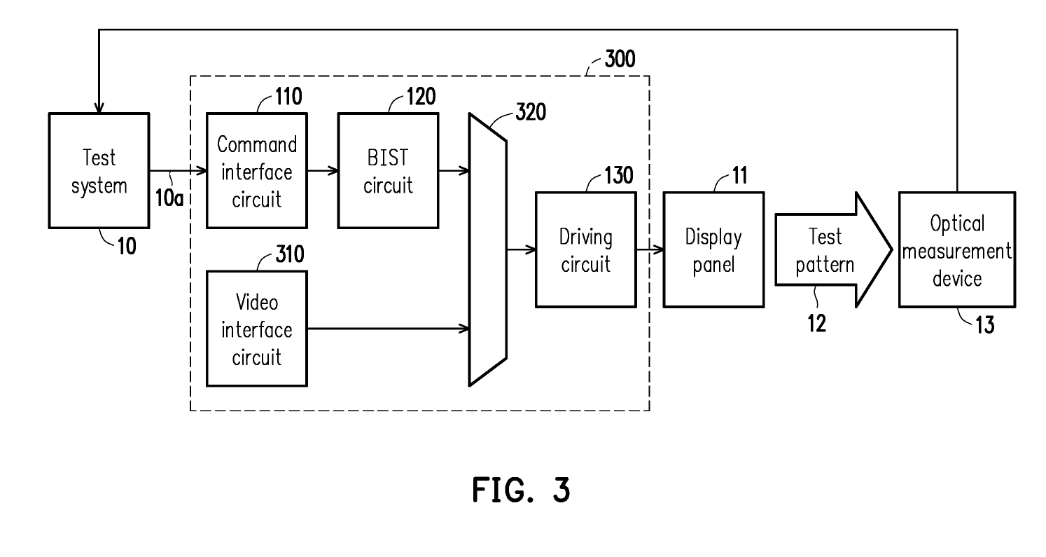

FIG. 3 is a schematic circuit block diagram illustrating a driving apparatus 300 of a display panel according to another embodiment of the invention. The driving apparatus 300 may generate a plurality of test frame data in an optical measurement. A test system 10, a test command 10a, the driving apparatus 300, a display panel 11, a test pattern 12 and an optical measurement device 13 may be inferred with reference to the test system 10, the test command 10a, the driving apparatus 100, the display panel 11, the test pattern 12 and the optical measurement device 13 of the embodiment illustrated in FIG. 1 and thus, will not be repeatedly described. In a scenario illustrated in FIG. 3, it shows that the driving apparatus 300 is operated in a test mode, i.e., the driving apparatus 300 is electrically connected to the test system 10. After a test is completed, the driving apparatus 300 may be disconnected from the test system 10, and then, the driving apparatus 300 and the display panel 11 are installed in an electronic product. Namely, in a normal operation mode, the driving apparatus 300 is electrically connected to a control circuit (not shown, for example, a processor) in the electronic product.

In the embodiment illustrated in FIG. 3, the driving apparatus 300 includes a command interface circuit 110, a BIST circuit 120, a drive unit 130, a video interface circuit 310 and a multiplexer circuit 320. The command interface circuit 110, the BIST circuit 120 and the driving circuit 130 illustrated in FIG. 3 may be inferred with reference to the description related to the embodiment illustrated in FIG. 1 and thus, will not be repeatedly described. In the test mode, the video interface circuit 310 may not be connected to any other external apparatus/circuit. In the normal operation mode, the video interface circuit 310 may be electrically connected to the control circuit (not shown, for example, the processor) in the electronic product, so as to receive video frame data.

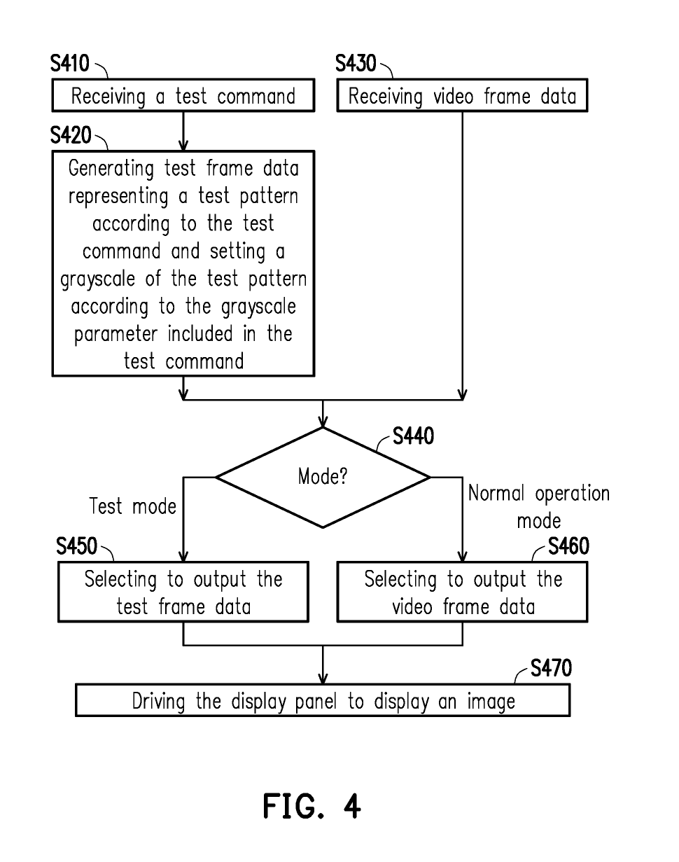

FIG. 4 is a flowchart illustrating an operating method of a driving apparatus of a display panel according to another embodiment of the invention. Referring to FIG. 3 and FIG. 4, the command interface circuit 110 receives the test command 10a in step S410. In step S420, the BIST circuit 120 generates the test frame data representing the test pattern 12 according to the test command 10a and sets the grayscale of the test pattern 12 according to the test command 10a. In step S430, the video interface circuit 310 receives the video frame data. The operation mode of the driving apparatus 300 may be determined in step S440. When the operation mode of the driving apparatus 300 is the test mode, step S450 is performed. When the operation mode of the driving apparatus 300 is the normal operation mode, step S460 is performed.

A first input terminal of the multiplexer circuit 320 is coupled to the BIST circuit 120 to receive the test frame data. A second input terminal of the multiplexer circuit 320 is coupled to the video interface circuit 310 to receive the video frame data. An output terminal of the multiplexer circuit 320 is coupled to an input terminal of the driving circuit 130. In the test mode, the multiplexer circuit 320 may select to output the test frame data provided by the BIST circuit 120 to the driving circuit 130 (step S450). In the normal operation mode, the multiplexer circuit 320 may select to output the video frame data provided by the video interface circuit 310 to the driving circuit 130 (step S460).

The driving circuit 130 can be coupled to the output terminal of the multiplex circuit 320. In step S470, the driving circuit 130 may drive the display panel 11 to display an image according to the test frame data or the video frame data output from the output terminal of the multiplex circuit 320. In the test mode, the image is the test pattern 12. In the normal operation mode, the image is a normal image.

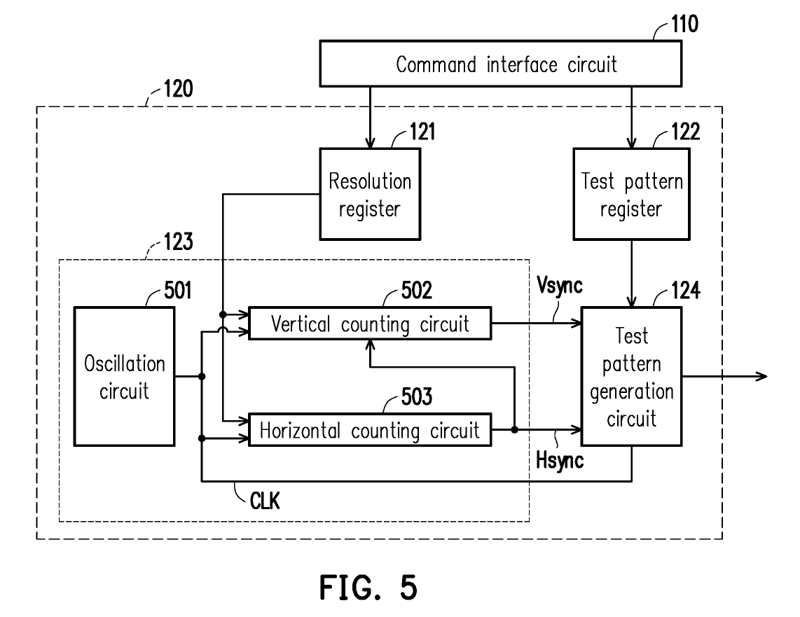

FIG. 5 is a schematic circuit block diagram illustrating the BIST circuit 120 depicted in FIG. 1 and/or FIG. 3 according to an embodiment of the invention. In the embodiment illustrated in FIG. 5, the BIST circuit 120 includes a resolution register 121, a test pattern register 122, a synchronization signal generation circuit 123 and a test pattern generation circuit 124. It is assumed here that the test command 10a of the test system 10 has at least one resolution parameter and at least one pattern parameter. The pattern parameter includes the grayscale parameter. The resolution parameter from the command interface circuit 110 may be stored in the resolution register 121, and the pattern parameter from the command interface circuit 110 may be stored in the test pattern register 122.

The synchronization signal generation circuit 123 can be coupled to the resolution register 121 to read the resolution parameter. The synchronization signal generation circuit 123 may correspondingly generate a vertical synchronization signal Vsync and a horizontal synchronization signal Hsync according to the resolution parameter. The test pattern generation circuit 124 can be coupled to the synchronization signal generation circuit 123 to receive the vertical synchronization signal Vsync and the horizontal synchronization signal Hsync.

In the embodiment illustrated in FIG. 5, the synchronization signal generation circuit 123 includes an oscillation circuit 501, a vertical counting circuit 502 and a horizontal counting circuit 503. The oscillation circuit 501 may generate a clock signal CLK. The vertical counting circuit 502 and the horizontal counting circuit 503 are coupled to the resolution register 121 to read the resolution parameter. The vertical counting circuit 502 and the horizontal counting circuit 503 are coupled to the oscillation circuit 501 to receive the clock signal CLK. The vertical counting circuit 502 may count the clock signal CLK to obtain a first count result. The horizontal counting circuit 503 may count the clock signal CLK to obtain a second count result. The horizontal counting circuit 503 may correspondingly generate the horizontal synchronization signal Hsync to the test pattern generation circuit 124 according to a relationship between the second count result and the resolution parameter. The vertical counting circuit 502 is further coupled to the horizontal counting circuit 503 to receive the horizontal synchronization signal Hsync. The vertical counting circuit 502 may correspondingly generate the vertical synchronization signal Vsync to the test pattern generation circuit 124 according to a relationship among the horizontal synchronization signal Hsync, the second count result and the resolution parameter.

The implementation manners of the oscillation circuit 501, the vertical counting circuit 502 and the horizontal counting circuit 503 are not limited in the present embodiment. For instance, the oscillation circuit 501 may include a conventional oscillator or any other oscillation circuit/element, the vertical counting circuit 502 may include a conventional vertical signal generator or any other vertical counting circuit/element, and the horizontal counting circuit 503 may include a conventional horizontal signal generator or any other horizontal counting circuit/element.

The test pattern generation circuit 124 can be coupled to the test pattern register 122 to read the pattern parameter (including the grayscale parameter). The test pattern generation circuit 124 may generate the test frame data according to the pattern parameter and set the grayscale of the test pattern 12 according to the grayscale parameter. The test pattern generation circuit 124 may output the test frame data to the driving circuit 130 illustrated in FIG. 1 or may output the test frame data to the multiplexer circuit 320 illustrated in FIG. 3. The specific content corresponding to the test pattern 12 of the test frame data may be determined based on a design requirement. For example, the test pattern 12 may be a one-color frame (e.g., a white frame, a red frame, a green frame or a blue frame), and the test pattern generation circuit 124 may set the grayscale of the one-color frame according to the grayscale parameter of the test pattern register 122.

The blocks of the BIST circuit 120, the driving circuit 130 and/or the test pattern generation circuit 124 may be implemented not only by a logic circuit (i.e., hardware) on an integrated circuit, but also by software through a central processing unit (CPU). In the latter case, related functions of the BIST circuit 120, the driving circuit 130 and/or the test pattern generation circuit 124 may be implemented as programming codes of software (i.e., programs). For example, the BIST circuit 120, the driving circuit 130 and/or the test pattern generation circuit 124 may be implemented by using general programming languages (e.g., C or C++) or other suitable programming languages. The aforementioned software (i.e., the programs) may be accessed by a computer (or the CPU) and recorded/stored in a read only memory (ROM), a storage device (or referred to as a recording medium) and/or a random access memory (RAM). Additionally, the programs may be accessed from the recording medium and executed by the computer (or the CPU) to accomplish the related functions. As for the recording medium, a non-transitory computer readable medium, such as a tape, a disk, a card, a semiconductor memory or a programmable logic circuit, may be used. In addition, the programs may be provided to the computer (or the CPU) through any transmission medium (e.g., a communication network or radio waves). The communication network is, for example, the Internet, wired communication, wireless communication or other communication media.

In different application scenarios, related functions of the BIST circuit 120, the driving circuit 130 and/or the test pattern generation circuit 124 may be implemented in a form of firmware or hardware by utilizing general programming languages (e.g., C or C++), hardware description languages (e.g., Verilog HDL or VHDL) or other suitable programming languages. In terms of the hardware implementation, one or more controllers, micro-controllers, application-specific integrated circuits (ASICs), digital signal processors (DSPs), field programmable gate arrays (FPGAs) and/or other various logic blocks, modules and circuits in other processing units may be employed to implement or execute the aforementioned functions of the embodiments of the invention. Moreover, the device and the method of the invention may be implemented by a combination of hardware and software.

Based on the above, the driving apparatus of the display panel and the operating method thereof provided by the embodiments of the invention can generate the test frame data representing the test pattern by using the BIST circuit. The grayscale of the test pattern can be dynamically set according to the grayscale parameter included in the test command of the external apparatus (e.g., the test system). Thus, the test frame data generated by the BIST circuit can be applied to adjust and calibrate the display parameters (e.g., the gamma curves and/or the color temperatures). Because the driving apparatus can self-generate the test frame data representing the test pattern. There is no need for configuring an external apparatus (e.g., the test system) to transmit the test frame data required by the measurement with a video interface between the external apparatus and the driving apparatus.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A driving apparatus of a display panel for generating a plurality of test frame data in an optical measurement, comprising:
a command interface circuit, configured to receive a test command comprising a grayscale parameter;
a video interface circuit, configured to receive video frame data;
a built-in self test (BIST) circuit, coupled to the command interface circuit to receive the test command, configured to generate test frame data representing a test pattern according to the test command and set a grayscale of the test pattern according to the grayscale parameter comprised in the test command;
a multiplex circuit, coupled to the BIST circuit to receive the test frame data, and coupled to the video interface circuit to receive the video frame data, wherein the multiplex circuit is configured to select to output the test frame data in a test mode, and select to output the video frame data in a normal operation mode; and
a driving circuit, coupled to an output terminal of the multiplex circuit, and configured to drive the display panel to display an image according to the test frame data or the video frame data output from the output terminal of the multiplex circuit.

2. The driving apparatus according to claim 1, wherein the grayscale parameter included in the test command comprises a plurality of bits for setting a grayscale for one of a red test pattern, a green test pattern, and a blue test pattern.

3. The driving apparatus according to claim 1, wherein the grayscale parameter included in the test command comprises a plurality of first bits, a plurality of second bits and a plurality of third bits, wherein the first bits are configured to set a red grayscale for a white test pattern, the second bits are configured to set a green grayscale for the white test pattern, and the third bits are configured to set a blue grayscale for the white test pattern.

4. The driving apparatus according to claim 1, wherein the BIST circuit comprises:
a test pattern register, configured to store at least one pattern parameter comprising the grayscale parameter; and
a test pattern generation circuit, coupled to the test pattern register, and configured to read the at least one pattern parameter, generating the test frame data according to the at least one pattern parameter, setting the grayscale of the test pattern according to the grayscale parameter, and outputting the test frame data to the multiplex circuit.

5. The driving apparatus according to claim 4, wherein the BIST circuit comprises:
a resolution register, configured to store a resolution parameter; and
a synchronization signal generation circuit, coupled to the resolution register, and configured to read the resolution parameter, and correspondingly generating a vertical synchronization signal and a horizontal synchronization signal according to the resolution parameter,
wherein the test pattern generation circuit is further coupled to the synchronization signal generation circuit and configured to receive the vertical synchronization signal and the horizontal synchronization signal.

6. The driving apparatus according to claim 5, wherein the synchronization signal generation circuit comprises:
an oscillation circuit, configured to generate a clock signal;
a vertical counting circuit, configured to be coupled to the resolution register to read the resolution parameter, coupled to the oscillation circuit to receive the clock signal, counting the clock signal to obtain a first count result, and correspondingly generate the vertical synchronization signal to the test pattern generation circuit according to a relationship between the first count result and the resolution parameter; and
a horizontal counting circuit, coupled to the resolution register to read the resolution parameter, coupled to the oscillation circuit to receive the clock signal, configured to count the clock signal to obtain a second count result, and correspondingly generate the horizontal synchronization signal to the test pattern generation circuit according to a relationship between the second count result and the resolution parameter.

7. The driving apparatus according to claim 1, wherein the command interface circuit is a serial peripheral interface or an inter-integrated circuit interface.

8. The driving apparatus according to claim 1, further comprising:
an one-time program circuit, configured to store a plurality of display setting parameters received from the command interface circuit,
wherein the display setting parameters comprise information associated with the test frame data.

9. The driving apparatus according to claim 1, wherein the driving apparatus is further coupled to a storage device, wherein the storage device is configured to store a plurality of display setting parameters received from the command interface circuit, and the display setting parameters comprise information associated with the test frame data.

10. A driving apparatus of a display panel for generating a plurality of test frame data in an optical measurement, comprising:
a command interface circuit, configured to receive a test command comprising a grayscale parameter;
a BIST circuit, coupled to the command interface circuit to receive the test command, and configured to generate test frame data representing a test pattern according to the test command and set a grayscale of the test pattern according to the grayscale parameter included in the test command; and
a driving circuit, configured to drive the display panel to display the test frame data.

11. An operating method of a driving apparatus of a display panel for generating a plurality of test frame data in an optical measurement, the operating method comprising:
receiving a test command comprising a grayscale parameter by a command interface circuit;
receiving video frame data by a video interface circuit;
generating test frame data representing a test pattern according to the test command and setting a grayscale of the test pattern according to the grayscale parameter comprised in the test command by a BIST circuit;
selecting to output the test frame data in a test mode by a multiplex circuit;
selecting to output the video frame data in a normal operation mode by the multiplexer circuit; and
driving, by a driving circuit, the display panel to display an image according to the test frame data or the video frame data output from the multiplex circuit.

12. The operation method according to claim 11, wherein the grayscale parameter comprised in the test command comprises a plurality of bits, and the bits are configured to set a grayscale for one of a red test pattern, a green test pattern and a blue test pattern.

13. The operation method according to claim 11, wherein the grayscale parameter comprised in the test command comprises a plurality of first bits, a plurality of second bits and a plurality of third bits, wherein the first bits are configured to set a red grayscale for a white test pattern, the second bits are configured to set a green grayscale for the white test pattern, and the third bits are configured to set a blue grayscale for the white test pattern.

14. The operation method according to claim 11, wherein the step of generating the test frame data comprises:
storing at least one pattern parameter comprising the grayscale parameter by a test pattern register;
generating the test frame data according to the at least one pattern parameter by a test pattern generation circuit;
setting the grayscale of the test pattern according to the grayscale parameter by the test pattern generation circuit; and
outputting the test frame data to the multiplex circuit by the test pattern generation circuit.

15. The operation method according to claim 14, wherein the step of generating the test frame data comprises:
storing a resolution parameter by a resolution register; and
correspondingly generating a vertical synchronization signal and a horizontal synchronization signal according to the resolution parameter by a synchronization signal generation circuit.

16. The operation method according to claim 15, wherein the step of generating the vertical synchronization signal and the horizontal synchronization signal comprises:
generating a clock signal by an oscillation circuit;
counting the clock signal to obtain a first count result by a vertical counting circuit;
correspondingly generating the vertical synchronization signal according to a relationship between the first count result and the resolution parameter by the vertical counting circuit;
counting the clock signal to obtain a second count result by a horizontal counting circuit; and
correspondingly generating the horizontal synchronization signal according to a relationship between the second count result and the resolution parameter by the horizontal counting circuit.

17. The operation method according to claim 11, wherein the command interface circuit is a serial peripheral interface or an inter-integrated circuit interface.

18. The operating method according to the claim 11, further comprising:
storing a plurality of display setting parameters received from the command interface circuit by an one-time program circuit,
wherein the display setting parameters comprise information associated with the test frame data.

19. The operating method according to the claim 11, further comprising:
storing, by a storage device, a plurality of display setting parameters received from the command interface circuit,
wherein the display setting parameters comprise information associated with the test frame data.
